(19) United States
(12) Patent Application Publication
(10) Pub. No.: US 2024/0273390 A1
(43) Pub. Date: Aug. 15, 2024

(54) MACHINE LEARNING RISK DETERMINATION SYSTEM FOR TREE BASED MODELS

(71) Applicant: Experian Information Solutions, Inc., Costa Mesa, CA (US)

(72) Inventors: Brian Duke, Poway, CA (US); David Zaleta, San Diego, CA (US)

(21) Appl. No.: 18/471,659

(22) Filed: Sep. 21, 2023

Related U.S. Application Data
(63) Continuation of application No. 16/194,919, filed on Nov. 19, 2018, now abandoned.
(60) Provisional application No. 62/589,197, filed on Nov. 21, 2017.

(51) Int. Cl. G06N 5/045; G06F 16/901; G06N 7/01; G06N 20/00

(52) U.S. Cl. CPC G06N 5/045; G06F 16/9027; G06N 7/01; G06N 20/00

(57) ABSTRACT

The present disclosure describes systems and methods for determining correlation codes for tree-based decisioning models. In one embodiment, a method for determining correlation codes in a tree-based decision model includes: assigning each decision node in a tree-based decision model to a correlation code; initializing a risk sum for each correlation code; calculating, for all decision nodes in the tree-based decision model, a difference in risk between child nodes and respective parent nodes; updating the risk sum for each correlation code associated with the decision node used in the decision for the node; determining the feature with the highest risk sum; and determining the correlation code associated with the determined decision node.

### CROSS-REFERENCE TO RELATED APPLICATIONS

This application is a continuation of U.S. patent application Ser. No. 16/194,919 filed on Nov. 19, 2018, entitled “MACHINE LEARNING RISK DETERMINATION SYSTEM FOR TREE BASED MODELS”, which claims benefit of priority under 35 U.S.C. § 119(c) of U.S. Provisional Patent Application No. 62/589,197 filed on Nov. 21, 2017, and entitled “RISK DETERMINATION SYSTEM FOR GENERATING ACTION CODES FOR TREE BASED MODELS.” The entire content of the above referenced applications is hereby expressly incorporated herein by reference in its entirety.

### BACKGROUND

The disclosure relates to machine learning for use with tree-based models.

### SUMMARY OF THE DISCLOSURE

Embodiments of various systems, methods, and devices are disclosed for providing machine learning for use with tree based models to determine correlation factors within the tree-based models. The systems, methods, and devices of the disclosure each have several innovative aspects, no single one of which is solely responsible for the desirable attributes disclosed herein.

In one embodiment, a risk determination system includes a non-transitory data storage configured to store computer executable instructions for a risk determination system; and a hardware processor programmed to execute the computer executable instructions in the non-transitory data storage to cause the risk determination system to: assign each decision node in a tree-based decision model to a correlation code; initialize a risk sum for each correlation code; calculate, for all decision nodes in the tree-based decision model, a difference in risk between child nodes and respective parent nodes; update the risk sum for each correlation code associated with the decision node used in the decision for the node; determine the decision node with the highest risk sum; and determine the correlation code associated with the determined decision node.

In another embodiment, a computer-implemented method for determining action codes in a tree-based decision model, the computer-implemented method comprising, as implemented by one or more computing devices within a risk determination system configured with specific executable instructions: assigning each feature in a tree-based decision model to an action code; initializing a risk sum for each action code; calculating, for all nodes in the tree-based decision model, a difference in risk between child nodes and respective parent nodes; updating the risk sum for each action code associated with the feature used in the decision for the node; determining the feature with the highest risk sum; and determining the action code associated with the determined feature.

In a further embodiment, a non-transitory computer readable medium storing computer executable instructions thereon, the computer executable instructions when executed cause a risk determination system to at least: assign each feature in a tree-based decision model to an action code; initialize a risk sum for each action code; calculate, for all nodes in the tree-based decision model, a difference in risk between child nodes and respective parent nodes; update the risk sum for each action code associated with the feature used in the decision for the node; determine the feature with the highest risk sum; and determine the action code associated with the determined feature.

### BRIEF DESCRIPTION OF THE DRAWINGS

FIGS. 1A and 1B are flowcharts illustrating embodiments of processes that execute within the system disclosed herein.

FIG. 2 is an example tree representing an example embodiment of determination of action codes associated with a decision tree.

FIG. 3 is an exemplary block diagram representing hardware and/or software components of an example embodiment.

### DESCRIPTION OF VARIOUS EMBODIMENTS

A risk system may be used to identify potential risk by implementing decision-tree based models. Newly developed decision tree-based models, such as for example random forest, gradient boosting, and the like, are very powerful tools and provide accurate results for decisioning. In addition, such systems may include code for determining and generating adverse actions which can provide an indication as to why the decision-tree-based model generated the result it did.

Methods for determining actions or adverse action codes, including adverse action codes for regression models generally focus on the weight of evidence (“WoE” hereinafter) or risk for each bin of a feature, and then combining differences in risk or WoE with the regression coefficient to determine the adverse action codes. A similar approach could also work for neural network models. The segmentation keys for a segmented regression model could also generally be factored into reason codes as well. Since such an approach is formulaic, it is not generally well suited for tree-based models.

### Example Determination of Action Codes to Tree Based Models

Methods based on building a logistic regression and using the regression to determine reason codes for a decision tree yield a result which may be highly correlated with the true reasons for which, for example, a given transaction was risky according to the tree, but may not be exactly the reasons the transaction was risky according to the tree. As such, determining action codes when utilizing such tree-based models is somewhat difficult. Although the tree structure may make it easy to determine which features of the decision tree affect a score, the tree structure makes it challenging to assess how much each of the features affects the score. Thus, there is generally a need to implement methods and systems for determining action codes for tree-based decisioning models.

Using embodiments of the methods and systems disclosed herein, a risk system may generate adverse action codes in the same code or processes which the score is determined via the tree, using if/then logic. The maximum number of additional computations beyond the calculation of the score is the product of the depth of the tree and the number of trees, which are generally minimal. Finally, embodiments of the method disclosed herein help determine actual factors affecting end scores, not mere approximations thereof.

In one embodiment, the system includes modules programmed to generate adverse codes for a single decision tree. For random forests tree models, the averages of single tree results may then be calculated. In some embodiments, the averages may include weighted averages. For gradient boosted tree models, the sums of single tree results may be calculated.

### Example Process

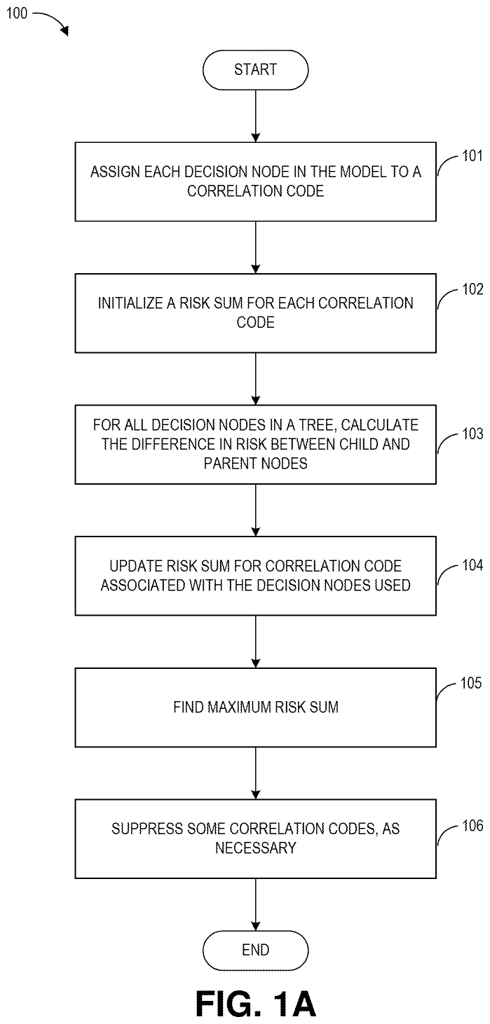

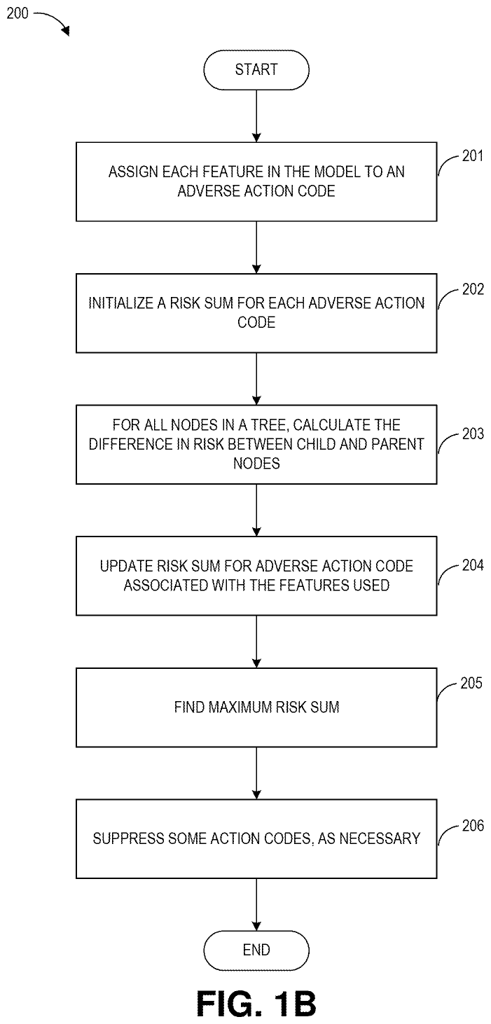

FIGS. 1A and 1B are flowcharts illustrating embodiments of processes that execute within the correlation code determination system disclosed herein.

As illustrated in the example of FIG. 1A, the method may include, in one embodiment, at block 101, assigning each decision node in the model to a correlation code. It is possible for multiple decision nodes to be mapped to the same correlation code. For example:

$${F}_{i} \to {A}_{j} .$$

At block 102, a risk sum is initialized for each correlation code. For example:

$$For all j : {S}_{j} = 0 .$$

At block 103, for all nodes in a tree, the difference in the risk between the child nodes and the parent nodes is calculated. For example, with the risk at a given node being defined as ρ:

For a given node n, with this transaction falling on side

$$\{ s : 1 , ρ \} {Δ}_{n , s} = {ρ}_{n , s} - {ρ}_{n} .$$

At block 104, the risk sum for the correlation code associated with the decision node used in the decision for this node is updated. For example:

$${S}_{j} = {S}_{j} + {Δ}_{n ,} s .$$

At block 105, the maximum Sⱼ is found, which can be associated with the first correlation code, then the second highest Sⱼ can be associated with the second correlation code, and so on. At block 106, any correlation codes that have Sⱼ<=0 may be suppressed. In other embodiments, correlation codes that have Sⱼ<=0 may be used, such as for example by taking the absolute value of Sⱼ before the maximum is found and or determining the minimum Sⱼ.

It is recognized that other processing may be performed and/or one or more processing steps may be omitted or the order may be altered.

### Example Use Case

As illustrated in the example of FIG. 1B, the method may include, in one embodiment, at block 201, assigning each feature in the model to an adverse action code. It is possible for multiple features to be mapped to the same adverse action code. For example:

$${F}_{i} \to {A}_{j} .$$

At block 202, a risk sum is initialized for each adverse action code. For example:
For all j: Sⱼ=0.

At block 203, for all nodes in a tree, the difference in the risk between the child nodes and the parent nodes is calculated. For example, with the risk at a given node being defined as ρ:

For a given node n, with this transaction falling on side

$$\{ s : 1 , ρ \} {Δ}_{n , s} = {ρ}_{n , s} - {ρ}_{n} .$$

At block 204, the risk sum for the adverse action code associated with the feature used in the decision for this node is updated. For example:

$${S}_{j} = {S}_{j} + {Δ}_{n ,} s .$$

At block 205, the maximum Sⱼ is found, which can be associated with the first adverse action code, then the second highest Sⱼ can be associated with the second adverse action code, and so on. At block 206, any adverse action codes that have Sⱼ<=0 may be suppressed. In other embodiments, adverse action codes that have Sⱼ<=0 may be used, such as for example by taking the absolute value of Sⱼ before the maximum is found and or determining the minimum Sⱼ.

It is recognized that other processing may be performed and/or one or more processing steps may be omitted or the order may be altered.

### Example Implementation Embodiment

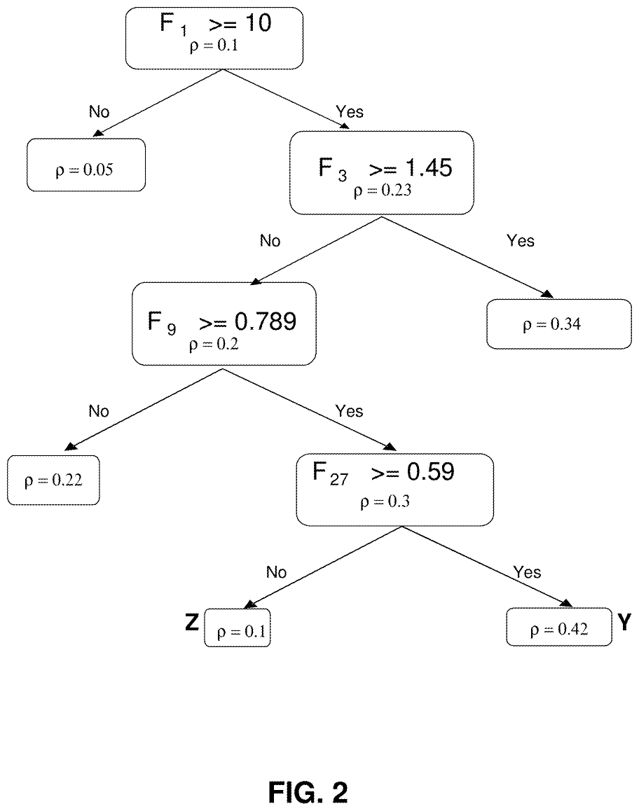

For illustrative purposes, an example embodiment of a tree is shown in FIG. 2. For purposes of a first example, assume a record falls into the cell Y at the bottom right of the tree.

The determination of adverse actions may proceed as follows. The difference in probabilities from cell Y to its parent (F₂₇) is:

$$0.42 - 0.3 = 0.12 . \qquad ( F 27 )$$

The other differences in probabilities are:

$$0.3 - 0.2 = 0.1 ; \qquad ( {F}_{9} )$$

$$0.2 - 0. 23 = - 0.03 ; \qquad ( {F}_{3} )$$

$$0.23 - 0.1 = 0 \text{.13} . \qquad ( {F}_{1} )$$

Therefore, the first adverse action would be determined to be associated with factor F₁, the second adverse action would be determined to be associated with F₂₇, and the third adverse action would be determined to be associated with F₉, since the respective sums are 0.13, 0.12 and 0.1. F₃ may be suppressed as a factor since the sum is a negative value.

For purposes of a second example, assume a record falls into the cell Z at the bottom left of the tree. The determination of adverse actions may proceed as follows.

The difference in probabilities from cell Z to its parent F₂₇ is:

$$0.1 - 0.3 = - 0.2 . \qquad ( F27 )$$

The other differences in probabilities are:

$$0.3 - 0.2 = 0.1 ; \qquad ( {F}_{9} )$$

$$0.2 - 0. 23 = - 0.03 ; \qquad ( {F}_{3} )$$

$$0.23 - 0.1 = 0 \text{.13} . \qquad ( {F}_{1} )$$

Therefore, the first adverse action would be determined to be associated with factor F₁, and the second adverse action would be determined to be associated with F₉, since the respective sums are 0.12 and 0.1. F₃ and F₂₇ may be suppressed as factors since the sums are negative values.

It is recognized that other processing may be performed and/or one or more processing steps may be omitted, or the order may be altered.

### Example System Implementation and Architecture

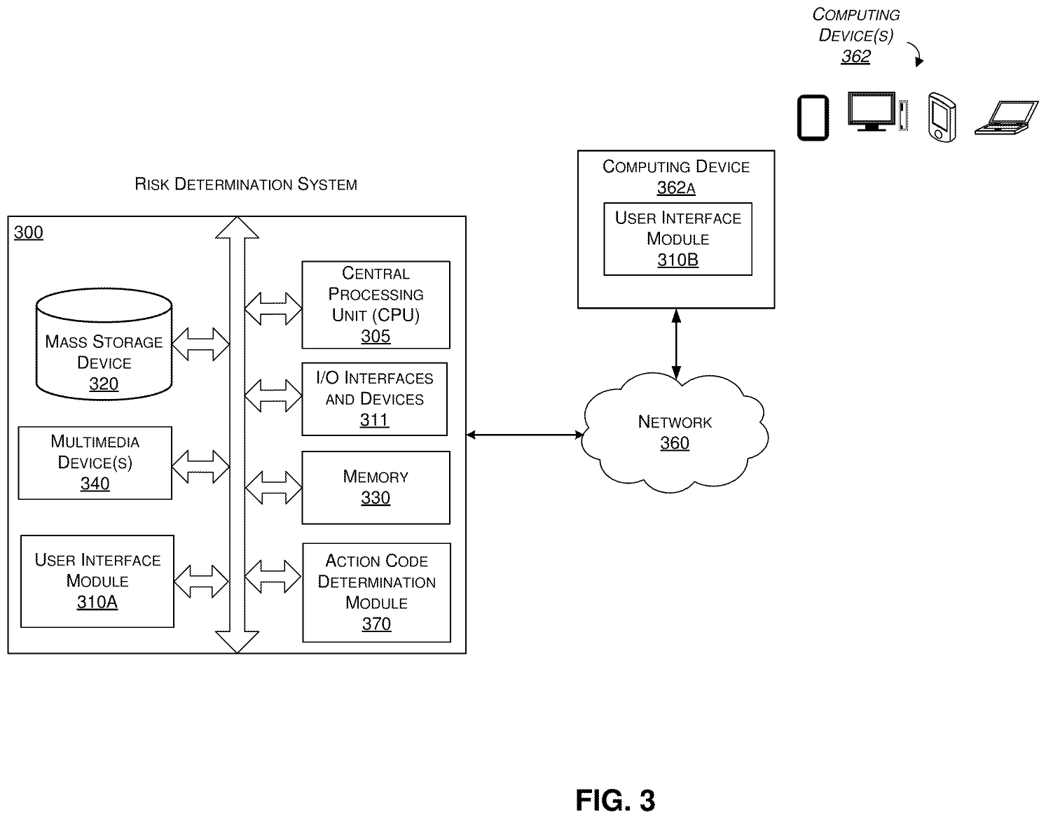

FIG. 3 is a block diagram of an example implementation of a risk determination system 300 in communication with a network 360 and various systems, such as computing device(s) 362. The risk determination system 300 may be used to implement systems and methods described herein. In some embodiments, the other computing devices discussed herein, such as the computing device(s) 362, may include some or all of the same components as discussed below with reference to risk determination system 300. Furthermore, depending on the embodiment, certain modules, such as the user interface module 310B included on a computing device 362 may be performed by different and or multiple computing devices. For example, certain user interface functionality described herein may be performed by the interface module 310B of a computing device 362A, certain user interface functionality described herein may be performed by a computing device 362B, while some functionality of may be performed by the interface module 310A of the risk determination system 300.

In an embodiment, various software modules are included in the risk determination system 300, which may be stored on the system itself, or on computer readable storage media separate from the system and in communication with the system via a network or other appropriate means.

The risk determination system 300 includes, for example, a personal computer that may be IBM, Macintosh, or Linux/Unix compatible or a server or workstation. In one embodiment, the risk determination system 300 comprises a server, a laptop computer, a smart phone, a personal digital assistant, a kiosk, or an media player, for example. In one embodiment, the exemplary risk determination system 300 includes one or more central processing unit (“CPU”) 305, which may each include a conventional or proprietary microprocessor. The risk determination system 300 further includes one or more memory 330, such as random access memory (“RAM”) for temporary storage of information, one or more read only memory (“ROM”) for permanent storage of information, and one or more mass storage device 320, such as a hard drive, diskette, solid state drive, or optical media storage device. Typically, the modules of the action code assignment system 300 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of risk determination system 300 may be combined into fewer components and modules or further separated into additional components and modules.

The risk determination system 300 is generally controlled and coordinated by operating system software, such as Windows XP, Windows Vista, Windows 7, Windows 8, Windows Server, Unix, Linux, SunOS, Solaris, IOS, Android, Blackberry OS, or other compatible operating systems. In Macintosh systems, the operating system may be any available operating system, such as MAC OS X. In other embodiments, the risk determination system 300 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary risk determination system 300 may include one or more commonly available input/output (I/O) devices and interfaces 311, such as a keyboard, mouse, touchpad, and printer. In one embodiment, the I/O devices and interfaces 311 include one or more display devices, such as a monitor, that allows the visual presentation of data to a user. More particularly, a display device provides for the presentation of GUIs, application software data, and multimedia presentations, for example. The risk determination system 300 may also include one or more multimedia devices 340, such as speakers, video cards, graphics accelerators, and microphones, for example.

In the embodiment of FIG. 3, the I/O devices and interfaces 311 provide a communication interface to various external devices. In the embodiment of FIG. 3, the risk determination system 300 is electronically coupled to a network 360, which comprises one or more of a LAN, WAN, and/or the Internet, for example, via a wired, wireless, or combination of wired and wireless, communication link. The network 360 communicates with various computing devices and/or other electronic devices via wired or wireless communication links.

In the embodiment of FIG. 3, the risk determination system 300 includes an action code determination module 370 and a user interface module 310A that may be stored in the mass storage device 320 as executable software codes that are executed by the CPU 305. This and other modules in the risk determination system 300 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 3, the risk determination system 300 is configured to execute the action code determination module 370 and the user interface module 310A to perform the various methods and/or processes as described herein (such as the process described with respect to FIG. 3 herein).

User interface module 310A or 310B may be configured to construct user interfaces of various types. In an embodiment, user interface module 310A or 310B constructs pages to be displayed in a web browser or computer/mobile application. The pages may, in an embodiment, be specific to a type of device, such as a mobile device or a desktop web browser, to maximize usability for the particular device. In an embodiment, user interface module 310A or 310B may also interact with a client-side application, such as a mobile phone application (an “app”) or a standalone desktop application, and provide data to the application as necessary to display information.

Computing devices 362, which may comprise software and/or hardware that implements the user interface module 310A, may be an end user computing device that comprises one or more processors able to execute programmatic instructions. Examples of such a computing devices 362 are a desktop computer workstation, a smart phone such as an Apple iPhone or an Android phone, a computer laptop, a tablet PC such as an iPad, Kindle, or Android tablet, a video game console, or any other device of a similar nature. In some embodiments, the client computing device 362 may comprise a touch screen that allows a user to communicate input to the device using their finger(s) or a stylus on a display screen. The computing device 362 (or any of the computing systems described herein, such as risk determination system 300), may comprise storage systems such as a hard drive or memory, or comprise any other non-transitory data storage medium. The storage systems may be configured to store executable instructions that may be executed by one or more processors to perform computerized operations on the client computing device, accept data input from a user (e.g. on the touch screen), and/or provide output to a user using the display. These executable instructions may be transmitted to another device for execution or processing by the device to implement the systems and methods described herein.

The computing devices 362 may also comprise one or more client program applications, such as a mobile “app” (for example iPhone or Android app) that may be used to visualize data, and initiate the sending and receiving of messages in the risk determination system 300. This app may be distributed (for example downloaded) over the network to the client computing devices directly from the risk determination system 300, or from various third parties such as an Apple iTunes or Google Play repository or other “app store.” In some embodiments, the application may comprise a set of visual interfaces that may comprise templates to display action code information. In some embodiments, as described above, visual user interfaces may be downloaded from another server or service, such as the risk determination system 300. This may comprise downloading web page or other HTTP/HTTPS data from a web server and rendering it through the “app”. In some embodiments, no special “app” need be downloaded and the entire interface may be transmitted from a remote Internet server to computing device 362, such as transmission from a web server that is a part of the risk determination system 300 to an iPad, and rendered within the iPad's browser.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the risk determination system 300, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein may be implemented as software modules, and may be represented in hardware or firmware. Generally, the modules described herein refer to logical modules that may be combined with other modules or divided into sub-modules despite their physical organization or storage.

### Other Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the risk determination system 300, computing device 362, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Other embodiments relating to the systems and methods disclosed herein are detailed in the Appendix of the provisional application to which the present application claims priority, the entirety of which is bodily incorporated herein and the entirety of which is also incorporated herein by reference.

1. (canceled)

2. A risk determination system, the risk determination system comprising:
a non-transitory data storage configured to store computer executable instructions for a risk determination system;
a hardware processor programmed to execute the computer executable instructions in the non-transitory data storage to cause the risk determination system to:
assign each decision node in a tree-based decision model to an adverse action code, the tree-based decision model using one or more factors to determine a fraud score for a transaction;
assign a probability of risk for each adverse action code;
determine, for the tree-based decision model, a difference in the probability of risk between child nodes and respective parent nodes beginning with a cell in the tree-based decision model associated with the probability of risk for the transaction;
for each of the decision nodes having an adverse action code associated with the one or more factors used to determine the fraud score for the transaction, update the probability of risk based on the difference;
determine the parent decision node associated with the greatest difference in risk;
determine the adverse action code associated with the determined parent decision node;
associate the determined adverse action code with a highest contributing factor of the one or more factors affecting the fraud score for the transaction; and
populate one or more templates with adverse action code information; and
a client computing device comprising one or more client computing applications and a user interface, the one or more client computing applications configured to receive the populated one or more templates and cause the client computing device to display the adverse action code information on the user interface.

3. The risk determination system of claim 2, wherein the tree-based decision model comprises at least one of: a random forest model or a gradient boosted model.

4. The risk determination system of claim 2, wherein differences in the probability of risk that are equal to or less than zero are suppressed.

5. The risk determination system of claim 2, wherein an absolute value of the difference in the probability of risk between child nodes and respective parent nodes is used to update the probability of risk.

6. The risk determination system of claim 2, wherein the risk determination system is further caused to:
determine a next decision node associated with next greatest difference in risk, the next greatest different in risk being less than the greatest difference in risk and greater others of the differences in risk that are associated with others of the decision nodes;
calculate the adverse action code associated with the next decision node; and
associate the calculated adverse action code with a next contributing factor of the one or more factors affecting the fraud score for the transaction.

7. A computer-implemented method for determining action codes in a tree-based decision model, the computer-implemented method comprising, as implemented by one or more computing devices within a risk determination system configured with specific executable instructions:
assigning each decision node in a tree-based decision model to an adverse action code, the tree-based decision model using one or more factors to determine a fraud score for a transaction;
assigning a probability of risk for each adverse action code;
determining, for the tree-based decision model, a difference in the probability of risk between child nodes and respective parent nodes beginning with a cell in the tree-based decision model associated with the probability of risk for the transaction;
for each of the decision nodes having an adverse action code associated with the one or more factors used to determine the fraud score for the transaction, updating the probability of risk based on the difference;
determining the parent decision node associated with the greatest difference in risk;
determining the adverse action code associated with the determined parent decision node;
associating the determined adverse action code with a highest contributing factor of the one or more factors affecting the fraud score for the transaction;
populating one or more templates with adverse action code information;
receiving at a client computing device the populated one or more templates; and
displaying the adverse action code information on a user interface associated with the client computing device.

8. The computer-implemented method of claim 7, wherein the tree-based decision model comprises at least one of: a random forest model or a gradient boosted model.

9. The computer-implemented method of claim 7, wherein differences in the probability of risk that are equal to or less than zero are suppressed.

10. The computer-implemented method of claim 7, wherein an absolute value of the difference in the probability of risk between child nodes and respective parent nodes is used to update the probability of risk.

11. The computer-implemented method of claim 7 further comprising:
determining a next decision node associated with next greatest difference in risk, the next greatest different in risk being less than the greatest difference in risk and greater others of the differences in risk that are associated with others of the decision nodes;
calculating the adverse action code associated with the next decision node; and
associating the calculated adverse action code with a next contributing factor of the one or more factors affecting the fraud score for the transaction.

12. Non-transitory computer readable medium storing computer executable instructions thereon, the computer executable instructions when executed cause a risk determination system to at least:
assign each decision node in a tree-based decision model to an adverse action code, the tree-based decision model using one or more factors to determine a fraud score for a transaction;
assign a probability of risk for each adverse action code;
determine, for the tree-based decision model, a difference in the probability of risk between child nodes and respective parent nodes beginning with a cell in the tree-based decision model associated with the probability of risk for the transaction;
for each of the decision nodes having an adverse action code associated with the one or more factors used to determine the fraud score for the transaction, update the probability of risk based on the difference;
determine the parent decision node associated with the greatest difference in risk;
determine the adverse action code associated with the determined parent decision node;
associate the determined adverse action code with a highest contributing factor of the one or more factors affecting the fraud score for the transaction; and
populate one or more templates with adverse action code information;
receive at a client computing device the populated one or more templates; and
display the adverse action code information on a user interface associated with the client computing device.

13. The non-transitory computer readable medium of claim 12, wherein the tree-based decision model comprises at least one of: a random forest model or a gradient boosted model.

14. The non-transitory computer readable medium of claim 12, wherein differences in the probability of risk that are equal to or less than zero are suppressed.

15. The non-transitory computer readable medium of claim 12, wherein an absolute value of the difference in the probability of risk between child nodes and respective parent nodes is used to update the probability of risk.

16. The non-transitory computer readable medium of claim 12, wherein the computer executable instructions when executed further cause the risk determination system to at least:
determine a next decision node associated with next greatest difference in risk, the next greatest different in risk being less than the greatest difference in risk and greater others of the differences in risk that are associated with others of the decision nodes;
calculate the adverse action code associated with the next decision node; and
associate the calculated adverse action code with a next contributing factor of the one or more factors affecting the fraud score for the transaction.
